(19) United States
(12) Patent Application Publication
(10) Pub. No.: US 2014/0190459 A1
(43) Pub. Date: Jul. 10, 2014

(54) ANTI-FREEZING DEVICE FOR EGR DEVICE

(71) Applicant: Hiroshi Horiuchi, Hino-shi (JP)

(72) Inventor: Hiroshi Horiuchi, Hino-shi (JP)

(73) Assignee: HINO MOTORS, LTD., Hino-shi, Tokyo (JP)

(21) Appl. No.: 14/239,978

(22) PCT Filed: Sep. 3, 2012
(86) PCT No.: PCT/JP12/05553

§ 371 Date: Feb. 20, 2014

(30) Foreign Application Priority Data
Sep. 5, 2011 (JP) 2011-192397

(51) Int. Cl. F02M 25/07

(52) U.S. Cl. CPC F02M 25/0726
USPC 123/568.12

(57) ABSTRACT

In an anti-freezing device for an EGR device 14 with an EGR cooler 12 being provided midway of an EGR pipe 11 for extraction and recirculation of a part of exhaust gas from an exhaust side to an intake side, a downstream EGR pipe 11b downstream of the EGR cooler 12 being connected through a flange section 15 to an EGR valve 13, the flange section 15 is provided with a warm-water passage 16 to and from which engine warm water 22 is guided through warm-water conduits 23 and 24.

### TECHNICAL FIELD

The present invention relates to an anti-freezing device for an EGR device which prevents an EGR valve from freezing when ambient air is extremely low in temperature.

### BACKGROUND ART

Conventionally, so-called exhaust gas recirculation (EGR) has been conducted, for example, in a vehicle engine such that a part of exhaust gas is extracted and returned from an exhaust side to an intake side to suppress combustion of fuel in the engine, thereby lowering combustion temperature to reduce generation of NOₓ (nitrogen oxides).

Usually in this kind of EGR device for the exhaust gas recirculation, an appropriate position in an exhaust passage extending from an exhaust manifold to an exhaust pipe is connected through an EGR pipe with an appropriate position in an intake passage extending from an intake pipe to an intake manifold, thereby recirculating the exhaust gas through the EGR pipe.

An EGR cooler may be provided midway of the EGR pipe to cool the exhaust gas to be recirculated to the engine, which lowers and reduces a temperature and a volume of the exhaust gas to lower a combustion temperature without substantial decrease in output of the engine, thereby effectively suppressing generation of NOₓ.

In this kind of EGR device, for example, during cold idling with an exhaust brake being on in a cold district where an ambient air temperature is below freezing, water vapor in the exhaust gas may be condensed near an outlet of the EGR cooler; and the condensed water may accumulate in a tube of the EGR cooler and on an EGR valve arranged at the outlet of the EGR cooler, resulting in clogging of the tube of the EGR cooler or inoperativeness of the EGR valve due to freezing of the accumulating, condensed water. As a result, the EGR device may become inactive.

In order to overcome the above problem, conventionally, the EGR pipe is kept warm by wrapping heat-retaining and -insulating material around the EGR pipe. This is, however, troublesome with respect to an operation of wrapping the heat-retaining and -insulating material around the EGR pipe, leading to increase in cost; moreover, this may not reliably prevent the condensed water from freezing under the condition of extremely low temperature.

Thus, Patent Literature 1 in the name of the applicant of the present invention discloses an EGR vale wherein an actuator capable of operating a valve body has a housing including a water jacket with ports connectable to a coolant circulation system.

### CITATION LIST

### Patent Literature

[Patent Literature 1] JP 04-63960A

### SUMMARY OF INVENTION

### Technical Problems

However, the EGR valve shown in the Patent Literature 1 serves to circulate coolant to the water jacket in the housing to prevent temperature increase in components of the actuator, not to prevent the valve body from freezing. Therefore, when the coolant is circulated to the ports in the housing of the actuator in the Patent Literature 1 so as to prevent the valve body from freezing, the valve body may be indirectly warmed by the coolant at the ports, disadvantageously resulting in little temperature increase of the valve body and low effect on prevention of the accumulating, condensed water from freezing. Moreover, to provide the ports in the housing of the actuator makes the housing troublesome in production thereof.

The invention was made in view of the above and has its object to provide an anti-freezing device for an EGR device which can elevate, with a simple structure, temperature at an outlet of an EGR pipe to prevent an EGR valve arranged at the outlet of the EGR pipe from freezing.

### Solution to Problems

The invention is directed to an anti-freezing device for an EGR device wherein an EGR cooler is provided midway of an EGR pipe which extracts a part of exhaust gas from an exhaust side to recirculate the extracted exhaust gas to an intake side, a downstream EGR pipe downstream of said EGR cooler being connected through a flange section with an EGR valve, characterized in that said flange section is provided with a warm-water passage to and from which engine warm water is guided through warm-water conduits.

Thus, according to the anti-freezing device for the EGR device, the engine warm water is guided to the warm-water passage on the flange section which in turn connects the downstream EGR pipe downstream of the EGR cooler with the EGR valve, so that the flange section is warmed by the engine warm water. As a result, during cold, the condensed water guided in separation from the exhaust gas by the EGR cooler is prevented from freezing on the EGR valve positioned downstream of the flange section.

Preferably, the warm-water passage is provided by a passage groove on a flange surface of the outlet flange on the downstream EGR pipe; and the provision by the passage groove facilitates production of the downstream EGR pipe by casting.

Alternatively, the warm-water passage may be provided by a passage groove on a flange surface of the fixed flange for the EGR valve. Further alternatively, the warm-water passage may comprise a passage groove on the flange surface of the outlet flange on the downstream EGR pipe and a passage groove on the fixed flange for the EGR valve which are opposing to each other.

### Advantageous Effects of Invention

According to the anti-freezing device for the EGR device as mentioned in the above, the flange section, which connects the downstream EGR pipe downstream of the EGR cooler with the EGR valve, is provided with the warm-water passage for guidance of the engine warm water, so that the flange section is warmed by the engine warm water. Thus, during cold, the condensed water separated from the exhaust gas by the EGR cooler is prevented from freezing in the EGR valve positioned downstream of the flange section.

### BRIEF DESCRIPTION OF DRAWINGS

FIG. 1 is a plan view showing an example of an engine to which the invention is applied;

FIG. 2 is a side view showing an embodiment of an anti-freezing device for an EGR valve according to the invention;

FIG. 3 is a plan view looking in the direction of an arrow III in FIG. 2;

FIG. 4 is a side view showing an embodiment with a passage groove on a flange surface of a fixed flange for the EGR valve; and

FIG. 5 is a side view showing an embodiment with opposing passage grooves on the flange surface of the outlet flange for the downstream EGR pipe and on the flange surface of the fixed flange for the EGR valve, respectively.

### DESCRIPTION OF EMBODIMENTS

Next, embodiments of the invention will be described in conjunction with the drawings.

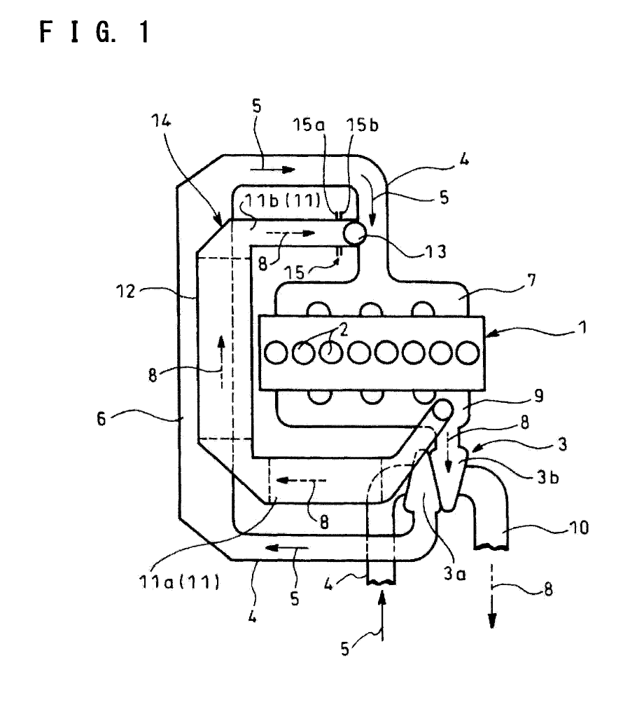

FIG. 1 is a plan view showing an example of an engine to which the invention is applied. Shown is a case where reference numeral 1 designates a diesel engine with a plurality of cylinders 2. The engine 1 is provided with a turbocharger 3, and intake air 5 guided from an air cleaner (not shown) to an intake duct 4 is fed to a compressor 3a of the turbocharger 3. The intake air 5 pressurized by the compressor 3a is fed to an intercooler 6 for cooling. The intake air 5 cooled by the intercooler 6 is guided through the intake duct 4 to a suction manifold 7 where the air is distributed to respective cylinders 2 of the engine 1.

Then, the exhaust gas 8 discharged through the respective cylinders 2 of the engine 1 is fed through an exhaust gas manifold 9 to a turbine 3b of the turbocharger 3. The exhaust gas 8 having driven the turbine 3b is discharged through an exhaust gas pipe 10 to outside of the vehicle.

The engine 1 is equipped with an EGR device 14 which in turn comprises an EGR pipe 11 extracting part of exhaust gas 8 from an exhaust gas manifold 9 to guide the same to an intake duct 4 at an inlet of the suction manifold 7, an EGR cooler 12 arranged midway of the EGR pipe 11 to cool the exhaust gas 8, and an EGR valve 13 arranged at the EGR pipe 11 downstream of the EGR cooler 12 and openable/closable to control an amount of the cooled exhaust gas 8 to be recirculated to the intake duct 4.

The EGR pipe 11 comprises upstream and downstream EGR pipes 11a and 11b upstream and downstream of the EGR cooler 12, respectively. The downstream EGR pipe 11b has an downstream outlet connected through a flange section 15 with the EGR valve 13 arranged at the intake duct 4. In FIG. 1, reference numeral 15a denotes an outlet flange at the outlet of the downstream EGR pipe 11b; and 15b, a fixed flange for the EGR valve 13 at the intake duct 4.

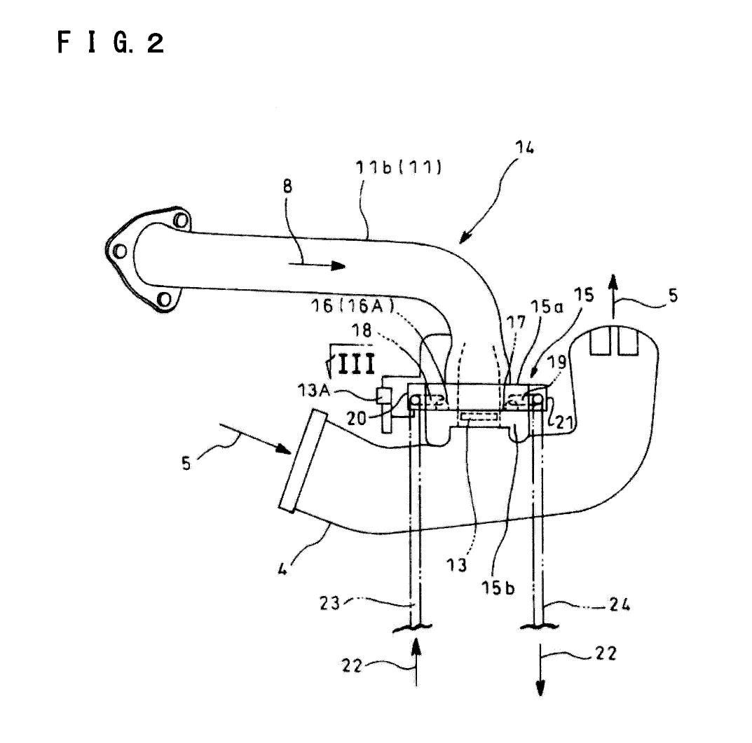

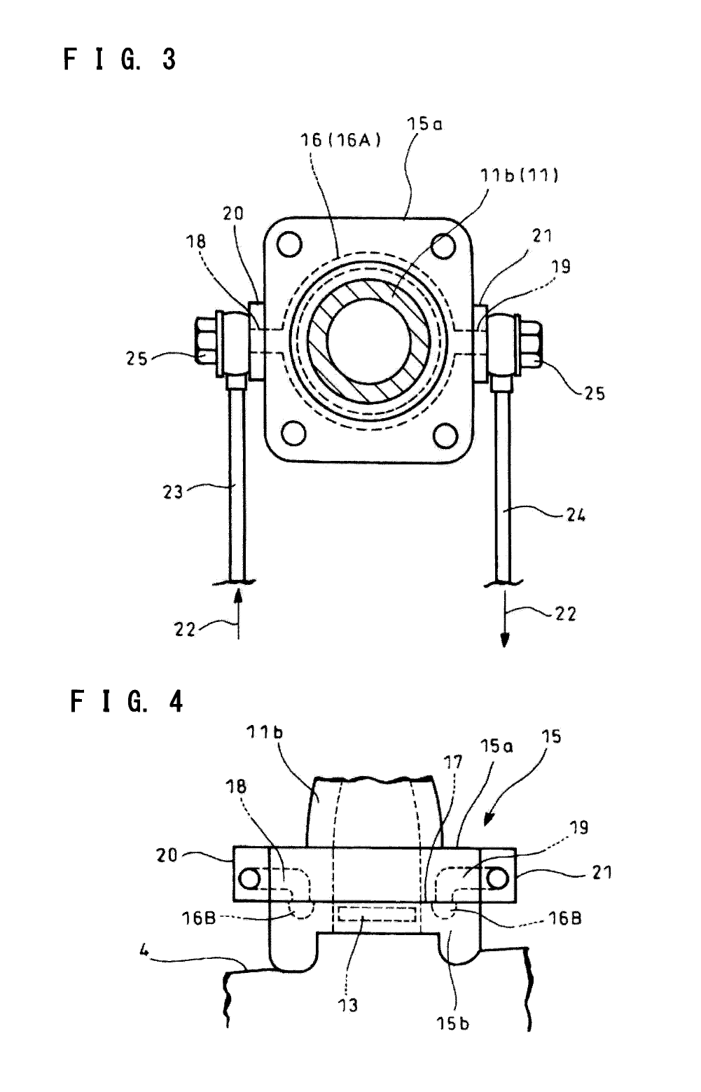

FIGS. 2 and 3 shows an embodiment of an anti-freezing device for an EGR device according to the invention arranged for the engine shown in FIG. 1, comprising a warm-water passage 16 provided for a flange section 15 which in turn comprises a fixed flange 15b for the EGR valve 13 assembled to the intake duct 4 and an outlet flange 15a provided for the downstream EGR pipe 11b and fastened to the fixed flange 15b.

Shown in FIG. 2 is a case where the warm-water passage 16 is provided by a passage groove 16A on a flange surface 17 of the outlet flange 15a on the downstream EGR pipe 11b. The warm-water passage 16 may be alternatively provided inside of the outlet flange 15a; however, the provision of the passage 16A on the flange surface 17 as shown in FIG. 2 is preferable for facilitation in production when the downstream EGR pipe 11b is produced by casting.

In lieu of the passage groove 16A on the flange surface 17 of the outlet flange 15a as shown in FIG. 2, a passage groove 16B may be formed on the flange surface 17 of the fixed flange 15b at the EGR valve 13 as shown in an embodiment of FIG. 4.

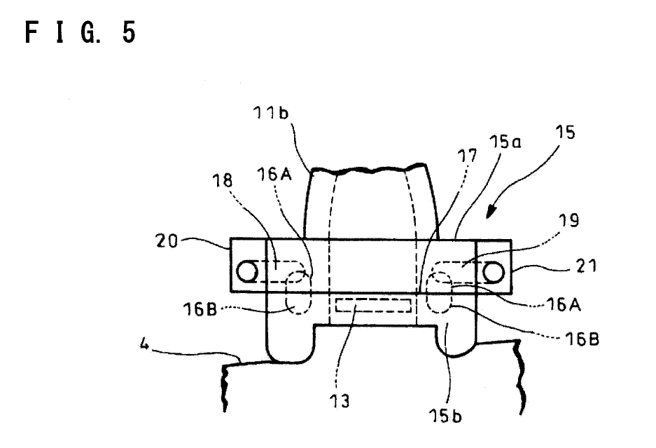

Further alternatively, as shown in an embodiment of FIG. 5, opposing passage grooves 16A and 16B may be formed on the flange surface 17 of the outlet flange 15a on the downstream EGR pipe 11b and on the flange surface 17 of the fixed flange 15b at the EGR valve 13. In FIG. 2, reference numeral 13A denotes a drive mechanism for adjustment of opening degree of the EGR valve 13.

As shown in FIGS. 2 and 3, provided at two positions on a periphery of the outlet flange 15a are projections 20 and 21 which have communication passages 18 and 19, respectively, in communication with the warm-water passage 16 and which are projected outwardly of the fixed flange 15b. Fixed through bolts 25 or the like to the projections 20 and 21 are warm-water conduits 23 and 24, respectively, which are in communication with the communication passages 18 and 19, respectively, so as to guide the engine warm water 22 to the warm-water passage 16. The warm-water passage 16 on the outlet flange 15a may be annular as shown in FIG. 3; alternatively, for example, a semicircular warm-water passage 16 may be used which has one and the other ends communicated with communication passages 18 and 19, respectively.

The warm-water conduit 23 is arranged so as to guide engine warm water 22, from a higher pressure portion in an engine block constituting the engine 1, to the communication passage 18; and the warm-water conduit 24 is arranged so as to return the engine warm water 22, flowing through the warm-water passage 16 and out of the communication passage 19, to a lower pressure portion in the engine block.

A mode of operation of the above embodiments will be described.

In the engine shown in FIG. 1, during cold idling with an exhaust brake being on in a cold district where an ambient air temperature is below freezing, water vapor in the exhaust gas 8 might be condensed in the downstream EGR pipe 11b at the outlet of the EGR cooler 12 and the condensed water might accumulate on the EGR valve 13, resulting in freezing and inoperativeness of the EGR valve 13 due to freezing of the accumulating, condensed water.

However, in the invention, as shown in FIGS. 2 and 3, the flange section 15 for connection of the EGR valve 13 with the downstream EGR pipe 11b is provided with the warm-water passage 16 to and from which the engine warm water 22 is circulated through the warm-water conduits 23 and 24, so that the flange section 15 is elevated in temperature by the engine warm water 22. Therefore, even if the condensed water accumulates on the EGR valve 13 arranged downstream of the flange section 15, the accumulating, condensed water is prevented from freezing. Thus, with the simple structure, the EGR valve 13 can be prevented from freezing even in a cold district, and the EGR device 14 can be reliably made functioning. Furthermore, production of the warm-water passage 16 is facilitated when the warm-water passage 16 is provided by either or both of the passage groove 16A on the flange surface 17 of the outlet flange 15a of the downstream EGR pipe 11b and the passage groove 16B on the flange surface 17 of the fixed flange 15b at the EGR valve 13.

It is to be understood that an anti-freezing device for an EGR device according to the invention is not limited to the above-mentioned embodiments and that various changes and modifications may be made without departing from the scope of the invention. For example, the warm-water passage may be variously changed in shape; and the invention is applicable to various types of engines with EGR device.

### INDUSTRIAL APPLICABILITY

An anti-freezing device for an EGR device according to the invention may be applied for prevention of condensed water from freezing in a cold district where water vapor in exhaust gas might be condensed in a downstream EGR pipe at an outlet of an EGR cooler and the condensed water might accumulate and freeze on an EGR valve.

### REFERENCE SIGNS LIST

8 exhaust gas
11 EGR pipe
11b downstream EGR pipe
12 EGR cooler
13 EGR valve
14 EGR device
15 flange
15a outlet flange
15b fixed flange
16 warm-water passage
16A passage groove
16B passage groove
17 flange surface
22 engine warm water
23,24 warm-water conduit

1. An anti-freezing device for an EGR device wherein an EGR cooler is provided midway of an EGR pipe which extracts a part of exhaust gas from an exhaust side to recirculate the extracted exhaust gas to an intake side, a downstream EGR pipe downstream of said EGR cooler being connected through a flange section with an EGR valve, characterized in that said flange section is provided with a warm-water passage to and from which engine warm water is guided through warm-water conduits.

2. The anti-freezing device for an EGR device as claimed in claim 1, wherein said warm-water passage is provided by a passage groove on a flange surface of the outlet flange on the downstream EGR pipe.

3. The anti-freezing device for an EGR device as claimed in claim 1, wherein said warm-water passage is provided by a passage groove on a flange surface of the fixed flange for the EGR valve.

4. The anti-freezing device for an EGR device as claimed in claim 1, wherein said warm-water passage comprises a passage groove on a flange surface of the outlet flange on the downstream EGR pipe and a passage groove on a flange surface of the fixed flange for the EGR valve.
